(19) United States
(12) Patent Application Publication
(10) Pub. No.: US 2005/0131639 A1
(43) Pub. Date: Jun. 16, 2005

(54) Methods, systems, and media for providing a location-based service

(75) Inventors: Scott Broussard, Cedar Park, TX (US); Ying Liu, Austin, TX (US); Eduardo Spring, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/733,841

(22) Filed: Dec. 11, 2003

(51) Int. Cl. G01S 1/00

(52) U.S. Cl. 701/209; 701/213; 342/357.06

(57) ABSTRACT

Methods, systems, and media for providing a location-based service are disclosed. Embodiments include hardware and/or software for receiving from a user at a current location differential information indicating a difference between the current location and a particular, different location, determining the current location, determining the particular location based on the current location and the differential information, providing a location-based service based at least partially on the particular location, and displaying information to the user. Embodiments may also include determining directional information between the current location and the particular location. In one embodiment, the differential information comprises a distance between the current and particular locations.

### CROSS-REFERENCES TO RELATED APPLICATIONS

Pursuant to 35 USC §119(e), this application claims priority to and benefit of U.S. patent application Ser. No. ______, entitled “METHODS, SYSTEMS, AND MEDIA FOR ACQUIRING RATINGS FOR POINTS OF INTEREST”, attorney docket number AUS920030903US1, filed on the same day, the disclosure of which is incorporated herein in its entirety for all purposes.

### FIELD OF INVENTION

The present invention is in the field of providing a location-based service. More particularly, the present invention relates to methods, systems, and media for providing a service based on a particular location, such as a location different than the current location of a user.

### BACKGROUND

Position-determining devices that provide a person with their current position have become ubiquitous in the early 21^{st} century. The Global Positioning System (“GPS”) was first developed by the U.S. military to provide positional information to its members. Recently, however, civilians have been provided access to the GPS system with acceptable accuracy. Now, the costs and availability of position-determining devices allow the average person to acquire accurate position-determining technology in a hand-held device.

The GPS system provides continuous three-dimensional positioning information throughout the world. The GPS system relies on a constellation of twenty-four (24) satellites orbiting the earth at approximately 10,900 miles, each orbiting the earth about twice a day. A GPS receiver seeks out and receives signals from a number of GPS satellites and uses each as a precise reference point. Based on information encoded into the signal received from each satellite and the amount of time the signal traveled, the distance between the GPS receiver and the satellite can be determined. The position of the GPS receiver can then be “triangulated” based on the distance of the receiver from the known positions of multiple satellites. Generally, receiving signals from two satellites can give latitude and longitude information and a third signal can also give elevation information. Fourth and additional satellite signals can serve to eliminate errors from satellite clocks, built-in inaccuracies of the GPS system, etc., to provide additional accuracy for three-dimensional positions. Because of inaccuracies inherent in the system, four or more satellite signals are usually desired for satisfactory accuracy. By using a GPS receiver receiving enough satellite signals, and individual can determine their current position relatively quickly and accurately.

GPS receivers, however, receive and keep signals best when a direct line-of-sight to an orbiting satellite is available. The most common reason to lose a satellite signal (or to fail to acquire it at all) is that the GPS satellite is below the horizon line for a particular receiver, as the signal will not travel through the earth. Because the satellites are roughly distributed uniformly around the globe, only a fraction of the full constellation of satellites is even theoretically available at one time. Another common reason to fail to “acquire” a satellite is the presence of an object blocking a GPS receiver's line-of-sight (such objects are sometimes called obstructions). Many common objects can serve as obstructions, such as buildings, landforms (e.g., mountains), trees, etc. Accordingly, if a building is located between the GPS receiver and the satellite, the receiver is very unlikely to receive a clean signal from the satellite. Similarly, a GPS receiver located in a tunnel would also have a difficult time acquiring GPS satellites.

Another problem with using GPS receivers is multipath, which is reflection of GPS signals near the antenna of the receiver. For example, reflections off of nearby objects, such as buildings, can confuse GPS receivers and produce inaccuracies or difficulties in acquiring signals. One way reflections can cause inaccuracies is by changing the amount of time it takes the signal to reach the GPS receiver and thus changing the calculated distance. Yet another problem with GPS receivers is radio frequency (RF) interference caused by nearby sources, which can seriously impact the performance of GPS receivers. Because of these restrictions, GPS-based position determination is unacceptable, inaccurate, or simply unavailable for some locations.

Because GPS receivers have become relatively inexpensive and portable, many people bring them along when traveling for business or pleasure, such as when hiking, going on a business trip, etc. As GPS technology has matured, the manufacture of GPS receivers has evolved into a highly competitive industry. Accordingly, many manufacturers or providers desire to increase their functionality and/or to improve existing deficiencies so as to increase their desirability in the eyes of consumers. To accomplish this, some manufacturers provide GPS receivers that come with mapping information to help provide a user of the receiver with a map of their area with their current position identified. For these systems, the GPS receiver provides a map, perhaps with nearby landmarks or other points of interest, based on the current position of the GPS receiver. These systems are plagued, unfortunately, with the fact that the areas in which an individual is most likely to get lost and need a map—in a city or crowded outdoor environment—are precisely the areas where GPS receivers are least likely to provide information, because of the difficulty in acquiring sufficient satellite signals or the possibility of multipath.

Even if someone has a map, they might have a hard time finding their destination as they may not know which direction to go, as people in strange locations often become disoriented or lost. This problem is even more prevalent when the terrain of any area makes it more difficult to see the surrounding area. For example, urban environments can be confusing, particularly if a person is in a tunnel, near large skyscrapers, etc. Rural or other environments have similar problems because of trees, landforms, etc.

### SUMMARY OF THE INVENTION

The problems identified above are in large part addressed by methods, systems, and media for providing location-based services related to a particular location. One embodiment provides a method for utilizing a location-based service. The method generally includes receiving from a user at a current location differential information indicating a difference between the current location and a particular, different location; determining the current location; determining the particular location based on the current location and the differential information; providing a location-based service, wherein the location-based service produces results that are at least partially based on the particular location; and displaying information to the user, wherein the information displayed to the user is at least partially based on the results of the location-based service.

Another embodiment provides an apparatus for utilizing a location-based service. The apparatus contemplates a position determining module for determining a current location; a compass, wherein the compass indicates directional information between the current location and the particular location; a user interface, wherein the user input comprises differential information indicating a difference between the current and particular locations; a service module, the service module providing a location-based service based on the particular location; and a display device.

A further embodiment provides a machine-accessible medium containing instructions, which when executed by a machine, cause said machine to perform operations. The operations can involve receiving from a user at a current location differential information indicating a difference between the current location and a particular, different location; determining the current location; determining the particular location based on the current location and the differential information; providing a location-based service, wherein the location-based service produces results that are at least partially based on the particular location; and displaying information to the user, wherein the information displayed to the user is at least partially based on the results of the location-based service.

One embodiment provides a method for providing a location-based service. The method generally involves receiving a request from a user at a current location for a location-based service based on a particular location; receiving the current location; receiving differential information between the particular location and the current location; determining the particular location based upon the differential information and the current location; providing a location-based service based on a particular location; and transmitting to the user results of the location-based service.

### BRIEF DESCRIPTION OF THE DRAWINGS

Other objects and advantages of the invention will become apparent upon reading the following detailed description and upon reference to the accompanying drawings in which like references may indicate similar elements:

FIG. 1 depicts an embodiment for a system for providing location-based services based on a particular location;

FIG. 2 depicts a schematic view of an apparatus according to one embodiment, including a position determining module and a compass;

FIG. 3 depicts a flow chart for requesting and receiving information from a location-based service according to one embodiment; and

FIG. 4 depicts a flow chart for providing a location-based service according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media to provide location-based services based on a particular location, such as a location different than the current location of a user, are contemplated. Embodiments include hardware and/or software for receiving from a user at a current location differential information indicating a difference between the current location and a particular, different location; determining the current location; determining the particular location based on current location and the differential information; and providing information from a location-based service, wherein the location-based service utilizes the particular location. Some or all of the information provided by the location-based service may be displayed to the user. In one embodiment, the differential information is a distance between the current location and the particular location. In one alternative embodiment, hardware and/or software for determining directional information between the current location and the particular location is also provided.

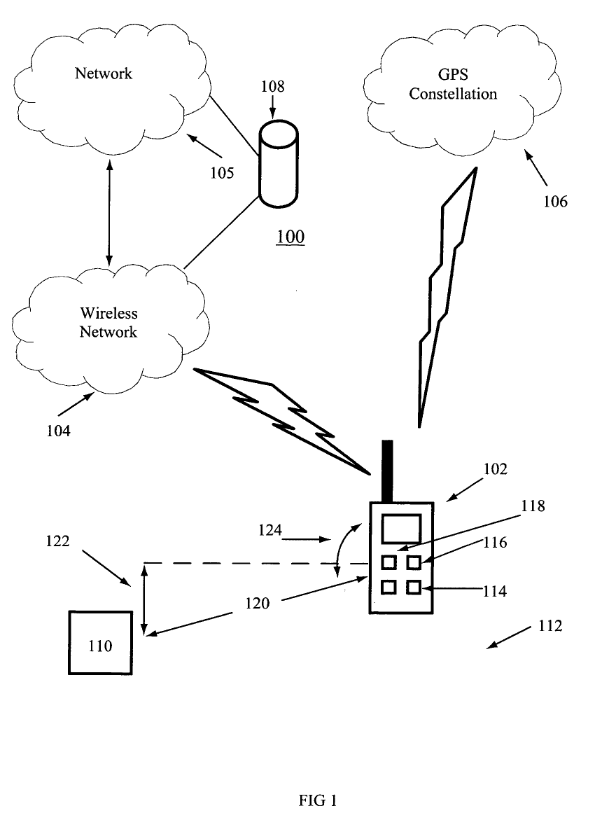

Turning now to the drawings, FIG. 1 depicts one embodiment of a system 100 for providing rating information related to a particular location. More specifically, system 100 facilitates providing to a user located at a current location location-based services that are based on a particular, different location. System 100 includes a position determining device 102 at a current location 112, an optional wireless network 104, and an optional GPS constellation 106. A particular location 110 may be physically located at a distance 120 from the position determining device 102 and current location 112.

Position determining device 102 is a device that is able to determine its current position. In one embodiment, position determining device 102 comprises a GPS receiver that may receive signals from GPS satellites in a GPS constellation 106. The GPS constellation 106 may contain one or more GPS satellites transmitting signals to one or more GPS receivers. In this embodiment, the position determining device 102 may be hand-held or mounted to a building, transportation device (e.g., automobile), etc., or located anywhere. The positioning determining device 102 may either be a stand-alone unit or it may be integral or connected to another device, such as a wireless phone, personal digital assistant (“PDA”), personal computer, automobile, navigation unit, pager, watch or other wearable item, Bluetooth-enabled device, etc.

Position determining device 102 may include a position determining module 116 and a compass 114. Position determining module 116 may include hardware and/or software capable of determining the present location of the position determining module 116, and, thus, the present location of the position determining device 102. In one preferred embodiment, position determining module 116 is a GPS receiver integrated into the position determining device 102. In another embodiment, position determining module 116 is an add-on or aftermarket GPS receiver adapted to be connected to position determining device 102. In alternative embodiments, the position determining module 116 may be any system able to ascertain a current position, such as inertial measurement units, other satellite-based navigation systems, etc.

Compass 114 may include hardware and/or software to determine a compass direction. In one embodiment, compass 114 is a digital compass integrated with the position determining device 102. In an alternative embodiment, compass 114 may be an add-on or aftermarket compass, such as a digital compass, adapted to be connected to position determining device 102. Digital compass 114 could, in one embodiment, use an existing display of the position determining device 102 to display output. Alternatively, digital compass 114 could have a dedicated display or graphical interface or no user display at all. In another embodiment, compass 114 is a traditional magnetic compass that optionally provides output directly to the position determining device 102.

In one embodiment, the user interface 118 should be as simple as possible. The user can simply push existing buttons to fill out a form on their position determining device 102. The form, for example, could simply have options to enter differential information (such as a distance or angle) or an optional request button (to begin the process of requesting a particular location-based service). The form could be stored on the position determining device 102 itself, or could be delivered to the position determining device 102 upon request via the wireless network 104. As bandwidth is often very important, it is usually optimal to store the form on the position determining device 102. As position determining devices 102 often have difficult user interfaces 118, minimizing the frequency and level of user input will likely increase user satisfaction and usage.

In one embodiment of system 100, a wireless network 104 and/or other network 105 in communication with the position determining device 102 is provided. In this embodiment, position determining device 102 is also a mobile communication device adapted to communicate wirelessly via wireless network 104. In one embodiment, the position determining device 102 may communicate with a base station as part of the wireless network 104, which in turn is in communication with a mobile switching center, gateway mobile switching center (“GMSC”), or other elements of a wireless or cellular network. In one embodiment, a wireless network 104 communicates with another network 105, which may be any type of network. In one embodiment, network 105 is a telephone network (or other wireless or cellular network) that communicates with wireless network 104 via a GMSC. In another embodiment, wireless network 104 communicates with network 105, such as the Internet, using the Wireless Access Protocol (“WAP”) via a WAP gateway, which translates between the protocols of the WWW and the WAP protocols of position determining device 102.

Particular location 110 may be any object or position for which a user with a position determining device 102 desires related information or services. In one example, particular location 110 could be a building two hundred yards away from a user with a position determining module, where the user desires to utilize location-based services based on that particular location 110 (the building). The particular location 110 could be any type of object, such as a building, a mobile object (e.g., parked car), geographical feature (e.g., mountain, waterfall, etc.), or any other object. The particular location 110 could also be any type of position, such as something in the user's line of sight, a place of a defined distance in some direction (e.g., five miles ahead, 200 yards east, 4 blocks northeast, etc.), road intersection, trailhead, mountain peak, etc. The user with a position determining device 102 is located at a current location 112, which, like the particular location 110, may be any object, position, place, etc. where the user may be located.

In a preferred embodiment, particular location 110 is in a different position than the position determining device 102. The difference between the particular location 110 and the position determining device 102 may be described in terms of differential information. In one embodiment, differential information includes a distance 120 and directional information. In this embodiment, distance 120 is the distance between the particular location 110 and the position determining device 102 and the directional information is any information representing the angular difference between the particular location 110 and the position determining device 102, such as an angle 124. In another embodiment, differential information may also include a height 122. The height 122 may be any type of distance and represents the height difference, or difference in altitudes, between the position determining device 102 and the particular location 110. Similarly to the distance 120, the height 122 may be estimated by the user, calculated by a rangefinder or altimeter, etc.

The distance 120 may be in any type of units, such as feet, meters, miles or other distances, or other types of measurements, such as city blocks. The user may estimate distance based on any method, including guessing, use of signs or other information (e.g., road signs), or from a rangefinder. A rangefinder, such as a laser or infrared rangefinder, may be used to provide range distance to a user or directly to the position determining device 102.

Directional information, as described above, may include any information which provides an indication of the angular difference between the particular location 110 and the position determining device 102. In one embodiment, the directional information includes a reading from compass 114 when a user requests a reading. For example, when a user requests a location-based service using user interface 118 while pointing the position determining device 102 towards the particular location 110, the current reading of compass 114 (e.g., 30 degrees north-northeast) provides an indication of which direction the particular location 110 lies from the current position of the user. In another embodiment, directional information may include an angle of rotation; for example, a user may manually input that the particular location 110 is, say, 45 degrees from the direction the user is presently facing.

In some embodiments of system 100, if a user of a position determining device 102 desires to receive location-based services based on a particular location 110, the user would point position determining device 102 in the direction of particular location 110. Compass 114 would determine the direction in which particular location 110 lies. User, in one embodiment, would input an estimated distance 120 to the particular location 110 using the user interface 116 of the position determining device 102. The current location of the position determining device 102 is calculated by the position determining module 116. When the current location, direction to the particular location 110, and estimated distance 120 to the particular location 110 are known, the position of the particular location 110 can be calculated.

Location-based services include any services or information that are at least partially based on a position. For example, a service that provides reviews of any restaurants within one mile of a specified position is a location-based service. In one embodiment, location-based services provide information. Any type of information could be provided by a location-based service, such as directions, mapping information, ratings, reviews, descriptions, costs, hours of operation, menus, product availability, video information (e.g., photographs from the position), etc.

In one embodiment, location-based services are performed on a service system 108. The services system 108 may include a computer system, such as a server, with storage capability. In one embodiment, services system 108 includes a computer system such as an IBM eServer™ having one or more processors, or threads of processors, executing software and/or one or more state machines coupled with data storage devices such as random access memory (RAM), read only memory (ROM), flash memory, compact disc drives, hard drives, and the like. Software executing on the services system 108 may be adapted to receive and respond to a request for location-based services related to a particular location. The services system 108 may communicate with wireless network 104 directly or through another network 105, such as the Internet. The services system 108 may receive a request for a location-based service, process the location-based service, and transmit the results via wireless network 104.

Once the position of the particular location 110 is known, the user can then receive information from a location-based service based on that particular location 110. The ability to provide a location-based service based on a particular location 110 provides a number of advantages. In one situation, the particular location 110 may not be physically accessible by the user, such as if there was a physical impediment to reaching the particular location (e.g., lake, cliff, mountain side, traffic blockage, etc.). By providing location-based service based on the particular location 110, the location-based service becomes useful for that user who cannot reach the particular location 110. Another useful situation might occur if a user desires information about a particular location 110 that the user is heading towards or will soon be near. In this situation, a user may see a small town across a lake and desire to know whether there are any good restaurants nearby. Another example is if a user is on a ferry and heading towards a downtown area of a city and wants to locate highly-rated service establishments, such as a gym or masseuse. Yet another example is a user in an automobile who is running out of gas or having car trouble who may desire to know of service stations located at a service station at the next exit ten miles ahead.

Another potential benefit of providing location-based services for a particular location 110 is for cases when GPS receivers cannot achieve an accurate position at a location. For example, a user might desire location-based services based on a location where GPS receives cannot acquire enough satellites or suffer from multipath. A user could instead go to another location with good line-of-sight to the GPS satellites, input the differential information to the desired location (treating it as a particular location 110), and receive location-based services based on that location. One of ordinary skill in the art will recognize that many other embodiments are contemplated.

In one embodiment, the location-based service is a rating service. A rating service provides rating information on one or more points of interest based on a particular position, such as the particular location 110. Rating information may include virtually any type of information about points of interest (e.g., restaurants, stores, tourist sites, etc.) that are somehow related to the particular location 110. In one example, the particular location 110 might be a corner of a city block. The rating information could be, say, ratings of restaurants within a five block radius. When this rating information is transmitted ultimately to the user of the position determining device 102, the user could then choose a restaurant in the area of the particular location 110 based on the rating information. Rating information may also include a wide variety of information about the points of interest, including some type of rating of the point of interest, such as a rating by critics, users, other individuals, proprietors, the requesting user, etc. In one embodiment, rating information includes user-provided rating information about points of interest. To get rating information about points of interest near a particular, different location 110, a user could point a position determining device 102 towards the particular location 110, input an estimated distance 122, and receive rating information related to points of interest near the particular location 110. Rating services are described in more detail in U.S. patent application Ser. No. ______, entitled “METHODS, SYSTEMS, AND MEDIA FOR ACQUIRING RATINGS FOR POINTS OF INTEREST”, attorney docket number AUS920030903US1, incorporated previously herein.

In another embodiment, the location-based service is a mapping service. In a mapping service, a map of the area around the particular location 110 is provided. A user on a hike, for example, could point the position determining device 102 at a distant peak she wishes to climb (which becomes a particular location 110). The user could then receive a mapping service providing a map of the area around the peak, so that she could determine the best route up the peak. The map information may include contour lines, roads, landmarks, points of interest, photographs of the area, detailed information, etc.

In another embodiment, the location-based service is an information service. An information service provides information related to a particular location, such as a particular location 110. Any type of information could be includes, such as information about nearby restaurants, historical information, retail establishments, tourist sites, government facilities, other users, environmental information, etc. In yet another embodiment, the location-based service is an advertising service. An advertising service may provide directed or customized advertising based on the particular location 110 (e.g., nearby restaurants, local night clubs, etc.) and/or the user himself (e.g., directing advertising on Indian restaurants to users who prefer those, etc.). In yet another embodiment, the location-based service is a military service, such as targeting for the particular location 110. Any service based at least in part, directly or indirectly, on a location may be considered a location-based service.

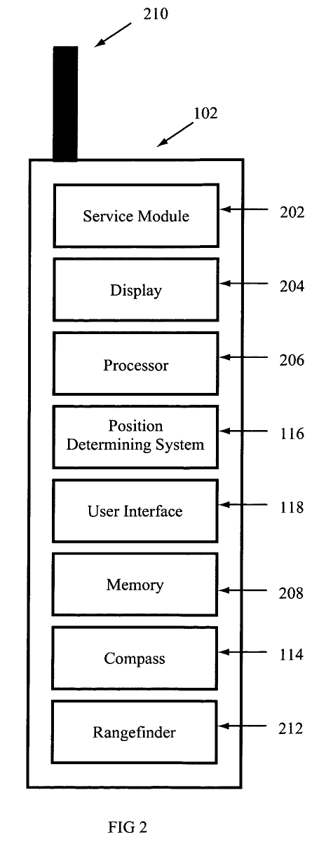

Referring now to FIG. 2, there is shown a schematic view of a position determining device 102 according to one embodiment, including a position determining module 116 and a compass 114. Position determining device 102 may include a service module 202, a display 204, a processor 206, a position determining module 116, a user interface 118, memory 208, a compass 114, a rangefinder 212, and an antenna 210. Service module 202 provides a location-based service, either by providing the service internally or by receiving the service from an outside source. In one embodiment, service module 202 includes hardware and/or software to transmit and receive information from a wireless network 104, where the service module 202 may work with optional antenna 210 to transmit and receive signals. In this embodiment, part or all of any location-based service is performed outside of the position determining device 102 (such as by a services system 108) and the service module 202 facilitates this, such as by transmitting a request for a location-based service and receiving the results of the location-based service. In another embodiment, service module 202 provides the location-based service using hardware and/or software on-board the position determining device 102.

Position determining device 102 includes a processor 206 and optional memory 208 for performing functions, storing user preferences, etc. Processor 206 may be used to perform necessary tasks for position determining device 102, such as calculations, handling the various subsystems, etc. In some embodiments, one processor 206 is used for execution of instructions; in other embodiments, one or more processors or threads of processor(s) 206 may execute instructions. Memory 160 may include random access memory (RAM) such as double data rate (DDR) synchronous dynamic RAM (SDRAM), caches, buffers, read only memory (ROM); flash memory, and/or remote data storage like magnetic disk storage media, optical storage media, and flash memory drives.

Position determining device 102 may include a display 204 and user interface 118. Display 204 may be, for example, a display screen for displaying information, such as the results of a location-based service, to the user. Any apparatus for conveying information to the user, such as a printer, is contemplated. User interface 118 may be any apparatus which accepts input from a user, such as buttons, dials, keys, keypad, levers, a voice recognition device, a device for accepting optical input, etc. In some embodiments, user interface 118 utilizes existing input devices, such as buttons or a touch-screen, so as to not require additional complexity.

As described in relation to FIG. 1, position determining device 102 includes a position determining device 116, such as a GPS receiver, and a compass 114, such as a digital compass. The position determining device 116 and compass 114 may be in communication with processor 206 so that processor 206 can handle directional and position information. In one embodiment, compass 114 is configured so that when a user points the position determining device 102 in the direction of a particular location 118, the compass 114 provides directional information between the user's current position and the particular location 118. For example, if the user is pointing the position determining device 102 due north, the compass 114 will indicate that the wireless device is pointing 102 due north. In one embodiment, the position determining device 102 is marked in some way so as to indicate to the user how to orient the position determining device 102 (e.g., antenna 210 pointing towards particular location 118) in order to provide the most accurate reading.

In one embodiment, a user could have a position determining device 102 configured so that the user points the antenna 210 towards the particular location 110 before requesting a location-based service based on that particular location 110. To request the location-based service, the user could select, for example, a service button on the user interface 118. Here, a user could point the antenna 210 towards, say, a building one mile away and select the service button 118. The system could then request that the user enter an estimated distance to the particular location 110. Alternatively, the user could point and hold the position determining device 102 towards the particular location 110 building while entering an estimated distance 120, where entering an estimated distance serves also as the request for a location-based service. In this embodiment, the compass 114 reading would be based on the reading at the moment the request was made. The user would then receive information from a location-based service based on a particular location 110 one mile away in the direction of the antenna 210 when the request was made.

Compass 114 may optionally provide an additional benefit to the user of the position determining device 102. Compass 114 can, obviously, provide directional information to the user, helping orient the user when they are located in a strange place. Moreover, compass 114, particularly if it is a digital compass, may be able to integrate with either mapping or direction software to assist the user in finding their destination. For example, if a user desires to go to another location (say, an address), software could create directions from their current location to that new location, and the compass 114 could help guide the user in the right direction.

Position determining device 102 may also optionally contain a rangefinder 212 for determining the distance from the position determining device 102 and some other location, such as the particular location 110. In one embodiment, a user may utilize a rangefinder 212 (e.g., laser, infrared, acoustic, etc.) to estimate a distance 120 or height 122 from a particular location 110 that they may then enter into the position determining device 102 using user interface 118. In an alternative embodiment, the rangefinder 212 interfaces directly with the position determining device 102 (e.g., the processor 206 or service module 202) so that user input is minimized.

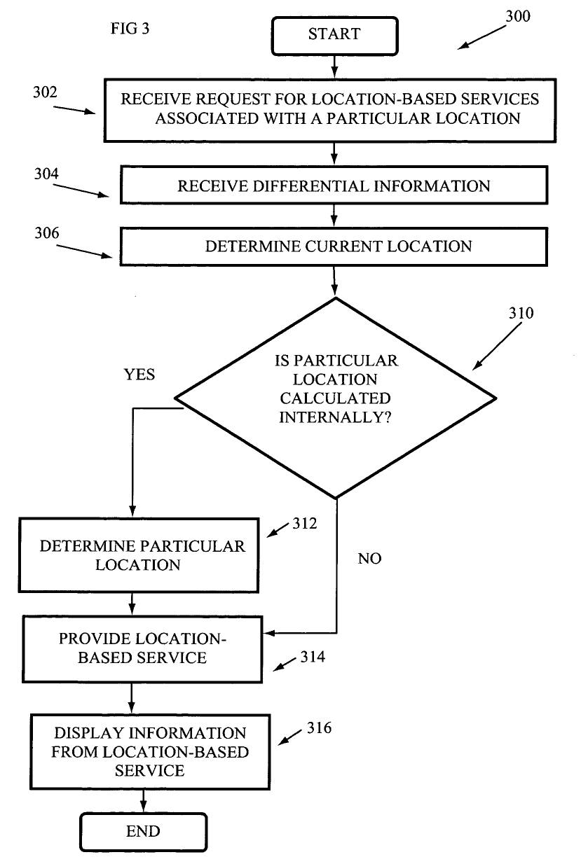

Referring now to FIG. 3, there is shown an example of a flow chart 300 for a method for requesting and receiving a location-based service based on a particular location according to one embodiment. Flow chart 300 begins with element 302, receiving a request for location-based services associated with a different location. The request for location-based services may be received from a user via a user interface 118, such as via a button on the position determining device 102. A user may also optionally supply preferences for the location-based services. In element 304, differential information is received from a user via a user interface 118 or from a component of the position determining module 116, such as a compass 114 or rangefinder 212. In one embodiment, differential information includes an estimated distance 120 (or height 122) between the user's location and a particular location 118 input via user interface 118. In this embodiment, directional information (such as an angle 124) is received from a compass 114. In one alternative embodiment, differential information is received in element 304 directly from a rangefinder device instead of from user input. In another alternative embodiment, input of differential information by a user is considered a request for rating information pursuant to element 302, thus performing elements 302 and 304 with one input from the user.

After receiving a request for rating information, the system determines the current position in element 306. In one embodiment, the current position is determined by a position determining module 116, as described in relation to FIGS. 1 and 2. The position determining module 116 may automatically (e.g., continually) calculate the current position of it may do so upon request. For the level of accuracy needed, positions calculated by the position determining device 116 reflect the position of the position determining device 102.

Element 310 illustrates a decision block based on whether the position of the particular location 110 is calculated internally to the position determining device 102 (e.g., via the processor 206) or external to the position determining device 102. If the particular location 110 is calculated internally, the particular location is then determined in element 312. The particular location 110 is calculated based on the current position and the differential information. A particular location 110 can be calculated, for example, if a starting location (e.g., current position), a compass direction (e.g., directional information), and a distance along that compass direction (e.g., distance 120) are known. In element 314, a location-based service is provided. In one embodiment, a location-based service related to the particular location 110 is provided internally without requiring a wireless network 104. In an alternative embodiment, a request for a location-based service related to the particular location 110 is transmitted via a wireless network 104 and the results of the location-based serviced are received. In this embodiment, such as when the position of the particular location 110 is determined internally, the position of the particular location 110 may be transmitted. In an alternative embodiment, such as when the position of the particular location 110 is not determined internally, the current position and differential information are both transmitted so that the particular location 110 can be determined later (such as by a services system 108). When the position of the particular location 110 is not determined internally (and is instead performed externally), element 312 may be skipped.

The results of the location-based service, such as information, are displayed to the user in element 316. As described in more detail in relation to FIGS. 1 and 2, a wide variety of information may be included in the results of the location-based service.

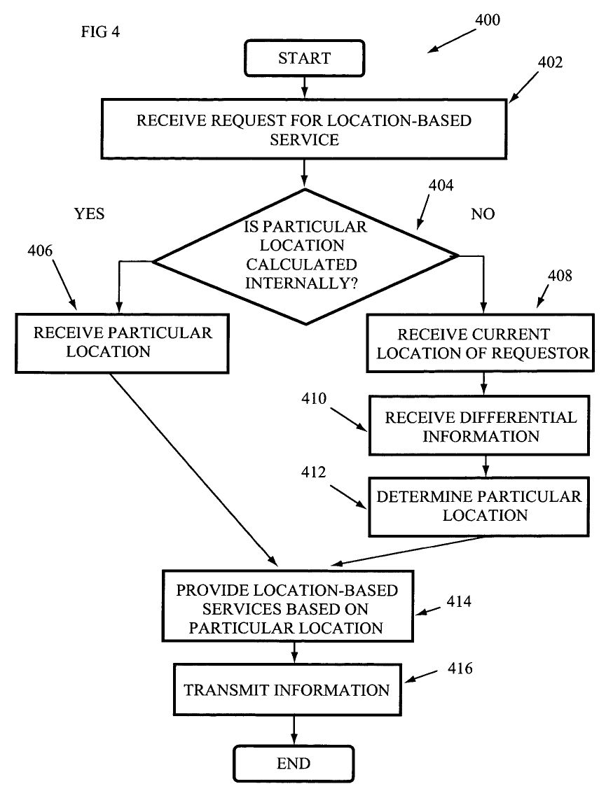

Referring now to FIG. 4, there is shown an example of a flow chart 400 for a method for providing a location-based service related to a particular location according to one embodiment. The method of flow chart 400 may be utilized externally at a services system 108, externally on a different system (e.g., a wirelessly connected local device, such as a Bluetooth-enabled enabled device), or any combination thereof. Flow chart 400 begins with element 402, receiving a request for a location-based service associated with a particular location. In one embodiment, the request for a location-based service is received from a service module 202 via a wireless network 104. The location for which the request is made is the particular location 110 and will be used in providing the location-based services. In this embodiment, the user may have originated the request for a location-based service via user input 116 on the position determining device 102.

As flow chart 400 continues to element 404, a split occurs depending on whether the position determining device 102 determines the particular location 110 internally or whether the particular location is determined external to the position determining device 102, such as at service system 108. If the position determining device 102 determines the particular location 110, the flow chart continues to element 406, receiving the position of the particular location 110 via the wireless network 104. If the position determining device 102 does not determine the position of the particular location 110, the flow chart continues to element 408, receiving the position of the requestor. After receiving the differential information in element 410, the function continues to element 412, calculating the position of the particular location 110. The position of the particular location 110 can be calculated, if necessary, using the position of the requestor and the differential information.

After the position of the particular location 110 is known (either from receiving it from the position determining device 102 or from determining it based on other information), the flowchart continues to element 414, providing location-based services based on particular location 110. After the location-based service is provided, the results (e.g., information) are transmitted via the wireless network 104 in element 416 and flowchart 400 terminates.

One embodiment of the invention is implemented as a program product for use with a computer system such as, for example, the system 100 shown in FIG. 1. The program product could be used on a position determining device 102, on a services system 108, or any combination thereof, or on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for providing location-based services based on a particular location, such as a location different than the current location of a user. It is understood that the form of the invention shown and described in the detailed description and the drawings are to be taken merely as examples. It is intended that the following claims be interpreted broadly to embrace all the variations of the example embodiments disclosed.

1. A method for utilizing a location-based service, the method comprising:
receiving from a user at a current location differential information, the differential information indicating a difference between the current location and a particular different location;
determining the current location;
determining the particular location based on the current location and the differential information received from the user;
providing a location-based service, wherein the location-based service produces results that are at least partially based on the particular location; and
displaying information to the user, wherein the information displayed to the user is at least partially based on the results of the location-based service.

2. The method of claim 1, further comprising determining directional information between the current location and the particular location.

3. The method of claim 2, wherein the directional information comprises an indication of compass direction between the current location and the particular location.

4. The method of claim 2, wherein the directional information comprises an angle of rotation.

5. The method of claim 1, wherein the differential information comprises an indication of the distance between the current location and the particular location.

6. The method of claim 1, wherein the differential information comprises an indication of a height.

7. The method of claim 1, wherein the location-based service is a ratings service.

8. The method of claim 1, wherein the location-based service is a mapping service.

9. The method of claim 1, wherein the location-based service is an information service, the information service providing information related to the particular location.

10. The method of claim 1, wherein the providing the location-based service comprises transmitting a request for a location-based service and receiving results from a location-based service.

11. An apparatus for utilizing a location-based service, the apparatus comprising:
a position determining module for determining a current location;
a compass, wherein the compass indicates directional information between the current location and a particular location;
a user interface for receiving user input, wherein the user input comprises differential information indicating a difference between the current location and the particular location;
a service module, the service module providing a location-based service based on the particular location; and
a display device to display at least some of the results of the location-based service to the user.

12. The apparatus of claim 11, further comprising a processor for determining the particular location based on the current location, directional information and the differential information.

13. The apparatus of claim 11, the service module comprising: a transmitter for transmitting a request for a location-based service based on the particular location; and
a receiver for receiving information related to the particular location; and

14. The apparatus of claim 11, wherein transmitter couples with the processor to transmit the particular location as part of the request for rating information.

15. The apparatus of claim 11, wherein the position determining module is a global positioning system receiver.

16. The apparatus of claim 11, wherein the compass is a digital compass.

17. The apparatus of claim 11, wherein the user interface is adapted to receive as an input differential information indicating a distance between the current location and the particular location.

18. The apparatus of claim 17, wherein the differential information comprises a distance.

19. A machine-accessible medium containing instructions, which when executed by a machine, cause said machine to perform operations, comprising:
receiving from a user at a current location differential information, the differential information indicating a difference between the current location and a particular, different location;
determining the current location;
determining the particular location based on the current location and the differential information received from the user;
providing a location-based service, wherein the location-based service produces results that are at least partially based on the particular location; and
displaying information to the user, wherein the information displayed to the user is at least partially based on the results of the location-based service.

20. The machine-accessible medium of claim 19, further comprising determining a compass direction between the current location and the particular location.

21. The machine-accessible medium of claim 19, wherein receiving the differential information comprises receiving an indication of the distance between the current location and the particular location.

22. A method for providing rating information, the method comprising:
receiving a request from a user at a current location for a location-based service based on a particular location;
receiving the current location;
receiving differential information between the particular location and the current location;
determining the particular location based upon the differential information and the current location;
providing a location-based service based on the particular location; and
transmitting to the user results of the location-based service.

23. The method of claim 22, wherein the differential information comprises directional information and a distance between the current location and the particular location.

24. The method of claim 22, wherein receiving the request comprises receiving the request from the user via a wireless network, and wherein transmitting to the user comprises transmitting results of the location-based service to the user via a wireless network.
